(19) United States
(12) Patent Application Publication
(10) Pub. No.: US 2015/0193393 A1
(43) Pub. Date: Jul. 9, 2015

(54) Dynamic Display of Web Content

(71) Applicants: Scott R. Violet, Sunnyvale, CA (US); Jeffrey A. Chang, Palo Alto, CA (US); John Nicholas Jitkoff, Palo Alto, CA (US); David Black, Mountain View, CA (US); Brian D. Rakowski, Mountain View, CA (US); Glen Murphy, Palo Alto, CA (US); Anthony C. Gentilcore, Palo Alto, CA (US)

(72) Inventors: Scott R. Violet, Sunnyvale, CA (US); Jeffrey A. Chang, Palo Alto, CA (US); John Nicholas Jitkoff, Palo Alto, CA (US); David Black, Mountain View, CA (US); Brian D. Rakowski, Mountain View, CA (US); Glen Murphy, Palo Alto, CA (US); Anthony C. Gentilcore, Palo Alto, CA (US)

(21) Appl. No.: 13/224,249

(22) Filed: Sep. 1, 2011

(51) Int. Cl. G06F 3/01; H04L 29/08; G06F 17/30

(52) U.S. Cl. CPC G06F 17/2247; G06F 17/30887; H04L 67/02

(57) ABSTRACT

Methods, systems, and apparatus, including computer programs encoded on a computer storage medium, for connecting to a first server to retrieve a first web page; presenting the retrieved first web page in a graphical user interface; and after receiving one or more characters in a string of characters entered into an input field of the graphical user interface, and before a submission action is received: identifying a different second web page for the string of characters; connecting to a second server to retrieve a second web page; replacing the presentation of the first web page with the second web page; after replacing the presentation, receiving one or more backspace characters entered into the input field; and in response to receiving the one or more backspace characters, replacing the presentation of the second web page with the presentation of the first web page.

### BACKGROUND

This specification relates to information retrieval.

Users can access a graphical user interface to obtain resources (e.g., web pages, images, video, and other information) from web servers located on the Internet. Resources residing on a server can be identified by a Uniform Resource Locator (“URL”) (e.g., “http://www.example.com”). Users can obtain access to such resources by directing the graphical user interface to a URL that identifies a location for the resource.

### SUMMARY

In general, one aspect of the subject matter described in the specification can be embodied in methods that include the actions of connecting to a first server to retrieve a first web page; presenting the retrieved first web page in a graphical user interface; and after receiving one or more characters in a string of characters entered into an input field of the graphical user interface, where the input field is an address bar of a web browser application, and before a submission action is received: identifying a different second web page for the string of characters; connecting to a second server to retrieve a different, second web page; replacing the presentation of the first web page with a presentation of the retrieved second web page; after replacing the presentation, receiving one or more backspace characters entered into the input field; and in response to receiving the one or more backspace characters, replacing the presentation of the second web page with the presentation of the first web page.

These and other aspects can optionally include one or more of the following features. The string is a substring of a uniform resource locator for the second web page. The string is not a substring of a uniform resource locator for the second web page. The submission action is entry of a non-alphanumeric character or selection of a visual element of the graphical user interface. The visual element is a button. The first web page includes search results that are responsive to a query previously entered into the input field. Identifying a different second web page corresponding to the string of characters includes: determining whether the string of characters represents a query; if the string of characters represents a query, submitting the query to a search engine and obtaining the second web page in response, wherein the second web page includes search results that are responsive to the query; and if the string of characters does not represent a query, selecting a uniform resource locator based at least in part on the string of characters and obtaining the second web page using the uniform resource locator. Connecting to a second server to retrieve a different, second web page is performed while maintaining the connection to the first server.

Particular embodiments of the subject matter described in this specification can be implemented so as to realize one or more of the following advantages. Users can dynamically retrieve and display resources (e.g., web pages) without having to enter a submission action (e.g., pressing the “Enter” or “Return” key). A first URL can be inputted into an input field on a graphical user interface to retrieve and display a first resource. A second URL can be entered into the input field on the graphical user interface, without entering a submission action, to dynamically retrieve and display a second resource. After displaying the second resource, and before a submission action is entered, one or more backspace characters can be entered into the input field to dynamically revert back to display of the first resource. A first URL corresponding to a first resource can be inputted into an input field on a graphical user interface, where the first resource is dynamically retrieved prior to entering a submission action, where the dynamic retrieval can be performed without displaying the first resource, and where the first resource can be displayed instantaneously upon entering a submission action, such that the instantaneous display creates a perception of faster web browsing. URLs entered into an input field can be autocompleted based in part on how often a user types or visits a particular URL.

Users can dynamically retrieve and display search results without having to enter a submission action (e.g., pressing the “Enter” or “Return” key). A first search query can be inputted into an input field on a graphical user interface to retrieve and display search results responsive to the first search query. A second search query can be entered into the input field on the graphical user interface, without entering a submission action, to dynamically retrieve and display search results responsive to the second search query. After displaying search results responsive to the second search query, and before a submission action is entered, a third search query can be entered into the input field to dynamically retrieve and display search results responsive to the third search query. In some implementations, a second URL can be entered into the input field on the graphical user interface, without entering a submission action, to dynamically retrieve and display a second resource. In connecting to the system associated with the second URL, the system can maintain its connection to the server from which search results were obtained, until a submission action is entered.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates interaction in an example system.

FIG. 2 is a flowchart of an example process for dynamically displaying web pages.

FIGS. 3A-3C are views of example graphical user interfaces illustrating dynamic presentation of web pages.

FIGS. 4A-4C are views of example graphical user interfaces illustrating dynamic retrieval and display of search results.

FIG. 5 is a schematic diagram of an example server.

Like reference numbers and designations in the various drawings indicate like elements.

### DETAILED DESCRIPTION

Users can connect to servers using a graphical user interface, as provided by a web browser or other computer software, to access resources (e.g., websites, images, and videos) hosted by those servers. More specifically, a user can access resources hosted by a server by instructing a graphical user interface to connect to a Uniform Resource Locator (“URL”) (e.g., “http://www.example.com”) that identifies the location of the resource on the server. A user can enter a URL into an input field (e.g., an address bar) located within the graphical user interface whereupon entry of the URL causes the graphical user interface to connect to a server associated with the URL and to subsequently access resources hosted by that server.

In various implementations, a user can instruct a system to connect to a first server to access a resource residing on the first server. The user can instruct the system using a graphical user interface on the system, where the instructions can involve inputting a string of characters into an input field of the graphical user interface to identify a location for the resource. For example, the user can input a string of characters that identify a location (e.g., “http://www.example.com”) for the resource that is residing on the first server. The system can connect to the first server using the URL to retrieve the resource residing on the first server. The resource retrieved from the first server can be presented using the graphical user interface. In some implementations, the inputted string of characters can identify a location for a resource residing on a user's local system (e.g., “file://C:/tmp/foo.html” or “http://localhost/foo.html”), where the resources can be retrieved locally and presented on the graphical user interface.

In addition, the user can instruct the system to connect to a second server to access a resource that is residing on the second server. In more detail, the user can input a string of characters into an input field of the graphical user interface to identify a location for the resource. For example, the user can input a string of characters that identify a URL location (e.g., “http://news.example.com”) for the resource that is hosted by the second server. Upon inputting the string of characters, and before a submission action is entered (e.g., pressing the “Enter” key), the system can identify a resource associated with the inputted string of characters (e.g., “http://news.example.com”) and can connect to the second server to retrieve the identified resource.

The system can update the graphical user interface to replace the presentation of the resource retrieved from the first server with the resource retrieved from the second server. For example, a graphical user interface displaying a web page associated with “http://www.example.com” can be updated to display a web page associated with “http://news.example.com” upon receiving input specifying “http://news.example.com” and before a submission action is entered. In some other implementations, after presentation of the resource retrieved from the first server is replaced with the resource retrieve from the second server, the user can interact with the graphical user interface to revert the presentation of the resource retrieved from the second server back to the resource retrieved from the first server. In some implementations, the user interaction involves inputting one or more backspace characters into the input field of the graphical user interface, where one or more characters in the inputted string of characters are deleted. For example, a graphical user interface displaying a web page associated with “http://news.example.com” can be reverted back to displaying the web page associated with “http://www.example.com” upon receiving one or more backspace characters in the input field.

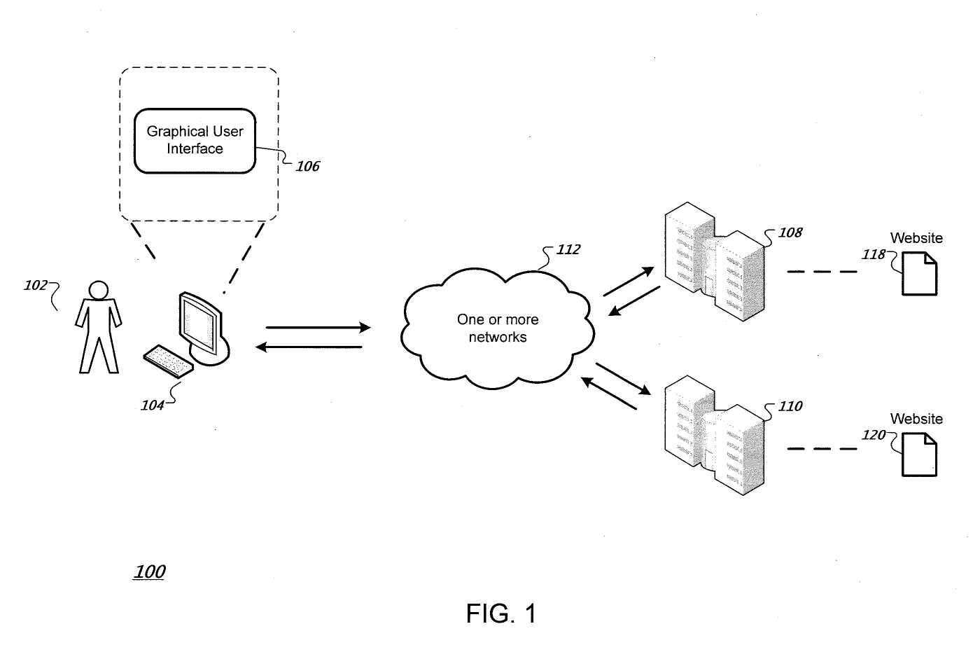

FIG. 1 illustrates interaction in an example system 100. A user 102 interacts with the system 104 to access a graphical user interface 106. The graphical user interface 106 can be used to obtain access to resources hosted by the web servers 108 and 110. In particular, the user can enter into the graphical user interface 106 a URL identifying a location for a resource hosted by the web servers 108 and 110. In some implementations, a user can input a string of characters into the graphical user interface 106, where the string of characters are used to search for responsive search results. Software that implements the graphical user interface 106 executes on the system 104. The graphical user interface 106 can present retrieved resources (e.g., web pages) to the user 102 by rendering Hypertext Markup Language (HTML) documents or other information obtained in connection with those resources.

A user 102 accessing the graphical user interface 106 on a system 104 can input a URL for a first web server 108 in an input field of the graphical user interface 106 to connect to the first web server 108. Upon connecting to the first web server 108, the system 104 can retrieve content for a resource (e.g., website 118) hosted by the first web server 108 and can present the retrieved website 118 on the graphical user interface 106. The user 102 can input into the graphical user interface 106 a URL for a second web server 110 to retrieve content for a resource (e.g., website 120) hosted by the second web server 110. The system 104 can communicate with the second web server 110 while maintaining a connection to the first web server 108. In particular, the system 104 can retrieve the website 120 and can present the retrieved website 120 on the graphical user interface 106. The system 104 can update the graphical user interface 106 to replace the presentation of website 118 with website 120. In some implementations, the user 102 can interact with the graphical user interface 106 to revert the presentation of website 120 back to website 118. In some implementations, the user interaction involves the user entering one or more backspace characters into the input field of the graphical user interface 106.

In some implementations, the user 102 accessing the graphical user interface 106 can input a first search query (e.g., a string of characters that is not a URL) in the input field of the graphical user interface 106 to obtain and display search results responsive to the first search query from a specified search engine. The user 102 can input into the graphical user interface 106 a second search query (e.g., a string of characters that is not a URL) to dynamically obtain and display search results responsive to the second search query from the specified search engine.

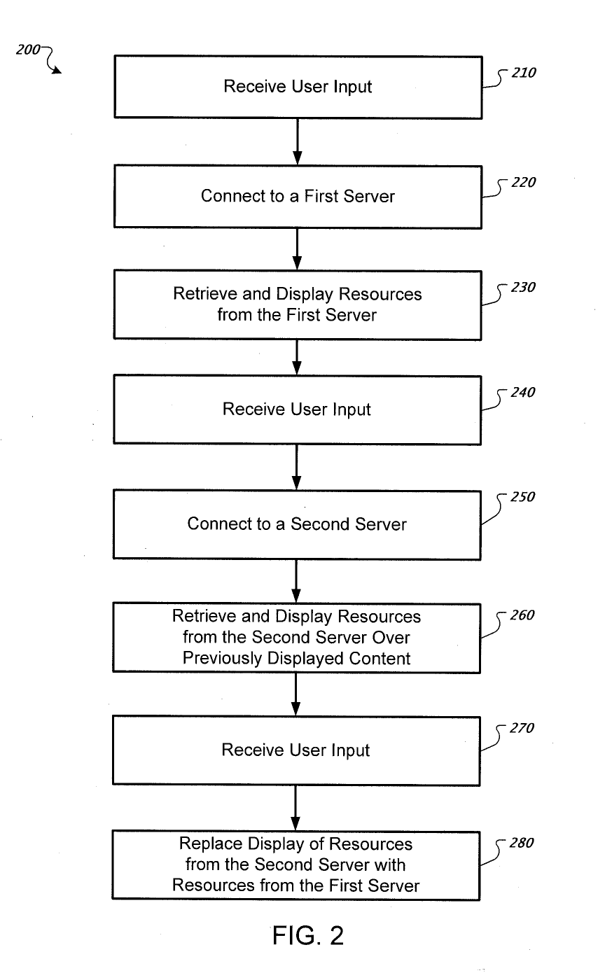

FIG. 2 is a flowchart of an example process for dynamically displaying web pages. The process 200 can be performed by a data processing apparatus, such as, for example, the system 100, as shown in FIG. 1.

The system receives input from a user specifying a first server (210). A user can specify a first server (e.g., a web server) by accessing a graphical user interface on the system. In some implementations, the user can input a string of characters into an input field within the graphical user interface to specify the first server. In some implementations, the inputted string of characters is a substring of a URL for a resource (e.g., a web page) located on the first server (e.g., “http://example.com”). In some implementations, entry of one or more characters of a URL into an input field can automatically be completed to the URL based in part on how often that URL is typed or visited. For example, if a user who frequently types or visits the URL “http://example.com” enters into an input field one or more characters of that URL (e.g., “e,” “ex,” or “exa”), then the URL can automatically be completed to “example.com” without further user input. In some implementations, a count of how often a user types or visits a URL can be determined based on the user's browsing history.

The system connects to the first server to obtain a resource (220). The system can connect to the first server over a network (e.g., the Internet) using a URL identifying the resource residing on the first server. The system can communicate with the first server using the Hypertext Transfer Protocol (HTTP). In some other implementations, the system can connect to a server using a URL upon entry of one or more characters of the URL into an input field. For example, if a user frequently types or visits the URL “http://example.com,” then entry of one or more characters of that URL (e.g., “e,” “ex,” or “exa”) can result in the system connecting to “http://example.com” without further user input.

The system retrieves and displays the resource residing on the first server (230). The system can retrieve resources (e.g., a web page) from the first server by communicating with the first server over a network (e.g., the Internet). The system can display the retrieved resources on the graphical user interface by rendering documents (e.g., Hypertext Markup Language (HTML) documents) or other information obtained in connection with the retrieved resources. For example, if a string of characters typed into the input field is detected as a retrievable URL (e.g., “http://example.com”), then the system can obtain and render the resource associated with that URL, and can display the resource to the user within the graphical user interface. In particular, the retrieved resource can be displayed within the graphical user interface without the user having to enter a submission action. A submission action is a key press (e.g., pressing the “Enter” or “Return” key), a sound or voice command (e.g., speaking the word “Search”), or is an interaction with the graphical user interface such as selection of a graphical element (e.g., a button or menu item) by using a computer mouse or other input device. In some implementations, the user can commit to the displayed resource by entering a submission action.

In some other implementations, the user input is a string of characters that are detected as not representing a URL, such that the string of characters is treated as a search query, where the system uses the search query to retrieve and display responsive search results. For example, if the string of characters typed into the input field is a term (e.g., “flowers”), then the system can obtain search results responsive to the term from a specified search engine. In particular, the search results obtained from the search engine can be displayed within the graphical user interface without the user having to input a submission action. In some implementations, the user can revise the search query by modifying the inputted string of characters in the input field (e.g., changing “flowers” to “flow”). In response to the revision, the system can dynamically obtain and display search results responsive to the modified string of characters.

The system receives input from the user specifying a second server (240). A user can specify the second server (e.g., a web server) by accessing the graphical user interface on the system. In some implementations, the user can input a string of characters into an input field within the graphical user interface to specify the second server. In some implementations, the inputted string of characters is a substring of a URL for a resource (e.g., a web page) located on the second server (e.g., “http://example.com”). In some implementations, the system determines whether input received from the user is a string of characters representing a search query. In a case where the string of characters represents a search query, the system submits the search query to a search engine and obtains search results that are responsive to the search query. In a case where the string of characters does not represent a search query, the system selects a URL based on the string of characters and obtains a resource associated with the URL.

The system connects to a second server to obtain a resource (250). The system can connect to the second server over a network (e.g., the Internet) using a URL identifying the resource residing on the second server. The system can communicate with the second server using the Hypertext Transfer Protocol (HTTP). For example, the user can input a string of characters that are detected as a retrievable URL (e.g., “http://news.example.com”) for the resource that is residing on the second server. Upon inputting the string of characters into the input field, and before a submission action is entered, the system can connect to the second server to obtain the identified resource.

In some implementations, a user can instruct a system to connect to a first server to obtain a collection of search results. The user can instruct the system using a graphical user interface on the system, where the instructions can involve inputting a string of characters into an input field of the graphical user interface to enter a search query (e.g., “how tall is mount everest”). The system can connect to the first server to obtain search results responsive to the search query. The obtained search results can be presented using the graphical user interface. In addition, the user can instruct the system to connect to a second server to access a resource that is residing on the second server. In more detail, the user can input a string of characters into an input field of the graphical user interface to identify a location for the resource. For example, the user can input a string of characters that identify a URL location (e.g., “http://news.example.com”) for the resource that is hosted by the second server. Upon inputting the string of characters, and before a submission action is entered (e.g., pressing the “Enter” key), the system can identify a resource associated with the inputted string of characters (e.g., “http://news.example.com”) and can connect to the second server to retrieve the identified resource. In connecting to the system associated with the second URL, the system can maintain its connection to the first server from which search results were obtained, until a submission action is entered or until user input is received (e.g., pressing a button that cancels loading of a web site).

The system retrieves and displays the resource residing on the second server (260). The system can retrieve resources (e.g., a web page) from the second server by communicating with the second server over a network (e.g., the Internet). The system can display the retrieved resources on the graphical user interface by rendering documents (e.g., Hypertext Markup Language (HTML) documents) or other information obtained in connection with the retrieved resources. For example, if a string of characters typed into the input field is detected as a retrievable URL (e.g., “http://news.example.com”), then the system can obtain and render the resource associated with that URL, and can display the resource to the user within the graphical user interface. In particular, the retrieved resource can be displayed within the graphical user interface without the user having to enter a submission action. In particular, the resource obtained from the second server can be displayed on the graphical user interface by replacing the resource that was obtained from the first server.

For example, if a graphical user interface is displaying a resource obtained from a first server (e.g., “http://example.com”), the user can input a URL in the input field of the graphical user interface, without entering a submission action, to obtain a resource from a second server (e.g., “http://news.example.com”), where the graphical user interface replaces display of the resource from the first server (e.g., “http://example.com”) with the resource from the second server (e.g., “http://news.example.com”).

In some implementations, the user can commit to the displayed resource that was retrieved from the second server by entering a submission action, where committing to the displayed resource can result in termination of the connection to the first server. In some implementations, a submission action involves entry of a non-alphanumeric character (e.g., pressing the “Enter” key). In some other implementations, a submission action involves selection of a visual element (e.g., a button) location within the graphical user interface.

In some other implementations, the system can be configured to prevent retrieval and display of a resource residing on a server based on a response received from the server. In some implementations, the system does not retrieve and display a resource residing on a server when the server responds to the system with an error message. For example, the system can be configured to prevent dynamic retrieval and display of a resource residing on a server when the server for that resource transmits an error message (e.g., an HTTP 404 error message) denying dynamic retrieval and display of the resource. In some alternative implementations, the system does not retrieve and display a resource residing on a server when the server responds to the system with a content warning message. For example, the system can be configured to prevent dynamic retrieval and display of a resource residing on a server when the server for that resource transmits a message indicating that the resource contains adult content. In some implementations, the content warning message is a numeric code (e.g., “100” indicating content for children, “200” indicating content for teenagers, “300” indicating content for adults), such that the system can be configured to dynamically retrieve and display resources that satisfy specified codes.

The system receives input from the user (270) and replaces displaying of resources from the second server with content from the first server (280). In some implementations, after display of the resource that was obtained from the first server is replaced with the resource that was obtained from the second server, and before a submission action is entered, the user can interact with the graphical user interface to revert the display back to the resource from the first server.

For example, if a graphical user interface was originally displaying a resource that was obtained from a first server (e.g., “http://example.com”) and that display was replaced with a resource that was obtained from a second server (e.g., “http://news.example.com”), the user can interact with the graphical user interface to revert the display back to the resource that was obtained from the first server (e.g., “http://example.com”). In some implementations, the user interaction involves inputting one or more backspace characters into the input field of the graphical user interface, where one or more characters in the inputted string of characters are deleted. Thus, continuing with the example above, if the user were to modify the inputted string of characters by deleting one or more characters from the inputted string of characters (e.g., modifying “http://news.example.com” to “http://news.example.co”), the system can revert the display back to the resource from the first server (e.g., “http://example.com”). In some other implementations, the user interaction involves selection of a visual element (e.g., a button) location within the graphical user interface. In yet some other implementations, the modification of the inputted string of characters involves inputting a URL for a resource associated with a third server (e.g., “http://games.example.com”), where the system retrieves and displays the resource associated with a third server.

Alternatively, after display of the resource that was obtained from the first server is replaced with the resource that was obtained from the second server, the user can commit to the resource retrieved from the second server by entering a submission action. In such instances, the system continues to display the resource retrieved from the second server on the graphical user interface while terminating its connection to the first server.

In some other implementations, the user input is a string of characters representing a search query, where the system uses the inputted search query to retrieve and display responsive search results. For example, if the string of characters typed into the input field is not a URL but rather one or more search terms (e.g., “flowers”), then the system can obtain search results responsive to the one or more search terms from a specified search engine. According to such implementations, after presentation of responsive search results for a first search query, the user can input a second search query (e.g., “flow) to dynamically retrieve and display search results responsive to the second search query.

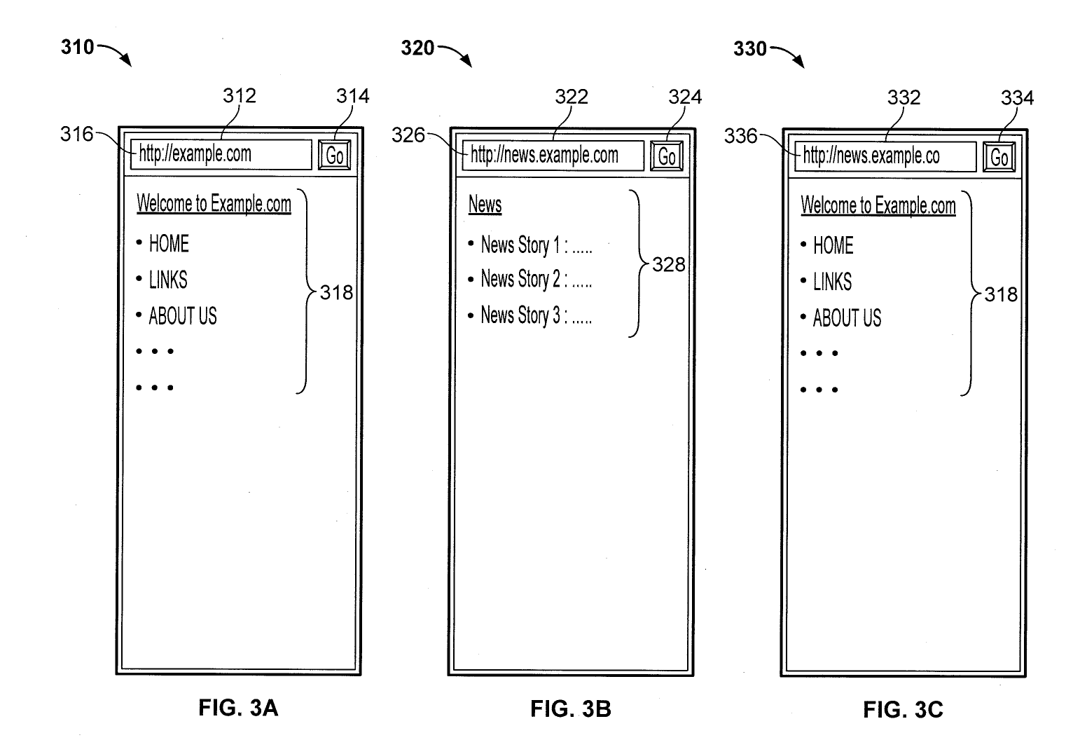

FIG. 3A is a view of an example user interface illustrating dynamic presentation of web pages. The user interface 310 includes an address bar 312, a submission button 314, a URL 316, and a retrieved web page 318. Users can retrieve resources from servers by inputting a URL in the address bar 312. As shown, the address bar 312 is populated with a URL 316 (“http://example.com”) without entering a submission action and a web page 318 corresponding to the inputted URL (“http://example.com”) is displayed.

FIG. 3B is a view of an example user interface illustrating dynamic presentation of web pages. The user interface 320 includes an address bar 322, a submission button 324, a URL 326, and a retrieved web page 328. As shown, the address bar 322 has been updated with a different URL 326 (“http://news.example.com”) without entering a submission action and the user interface has been dynamically updated to display a web page 328 corresponding to the inputted URL (“http://news.example.com”).

FIG. 3C is a view of an example user interface illustrating dynamic presentation of web pages. The user interface 330 includes an address bar 332, a submission button 334, a URL 336, and a web page 318. The URL 336 (“http://news.example.co”) has been updated to modify the URL (“http://news.example.com”) from FIG. 3B by deleting the character “m” without entering a submission action. In response to the modification, the user interface is dynamically updated to revert the display back to the web page 318 corresponding to the originally inputted URL 316 (“http://example.com”). In some implementations, the address bar 332 can be modified to input a new URL (e.g., “http://games.example.com”), such that a web page corresponding to the new URL is displayed within the user interface 330.

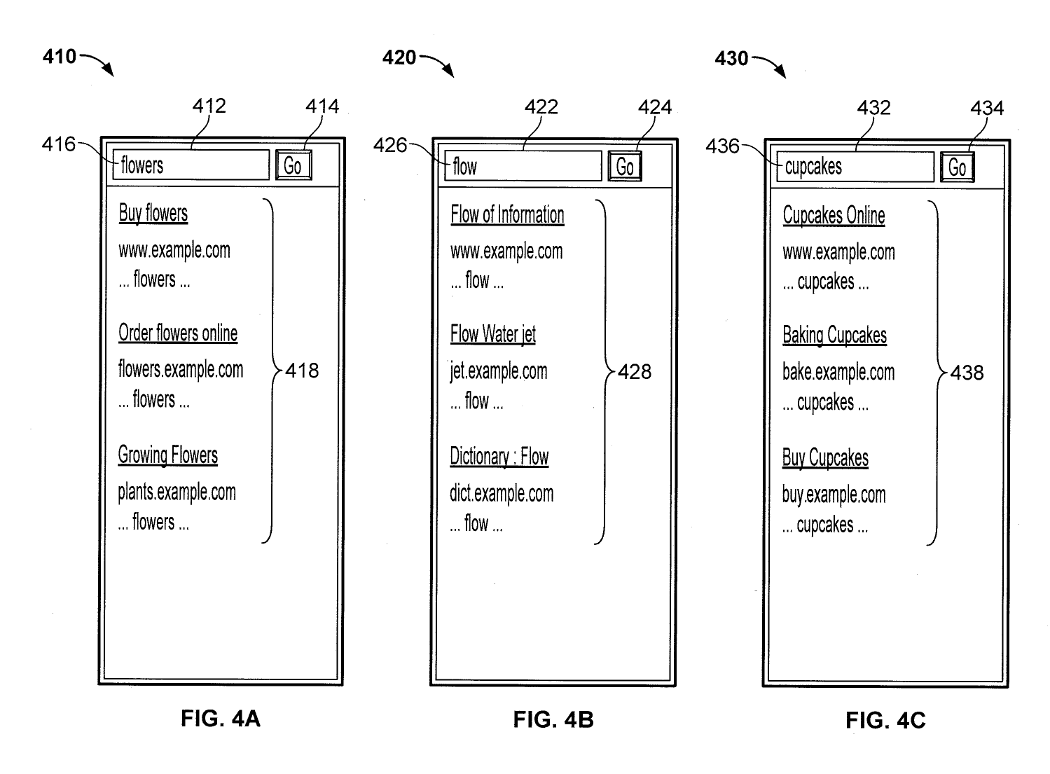

FIG. 4A is a view of an example user interface illustrating dynamic retrieval and display of search results. The user interface 410 includes an address bar 412, a submission button 414, a search query 416, and search results 418 responsive to the search query 416. Users can retrieve search results from a search engine by inputting search queries into the address bar 412. As shown, the address bar 412 is populated with a search query 416 (“flowers”) without entering a submission action and the user interface has been dynamically updated to display search results 418 responsive to the inputted search query 416.

FIG. 4B is a view of an example user interface illustrating dynamic retrieval and display of search results. The user interface 420 includes an address bar 422, a submission button 424, a search query 426, and search results 428 responsive to the search query 426. As shown, the address bar 422 is populated with a different search query 426 (“flow”) without entering a submission action and the user interface has been dynamically updated to display search results 428 responsive to the updated search query 426.

FIG. 4C is a view of an example user interface illustrating dynamic retrieval and display of search results. The user interface 430 includes an address bar 432, a submission button 434, a search query 436, and search results 438 responsive to the search query 436. The search query 436 (“cupcakes”) inputted into the address bar 432 modifies the search query that was inputted in FIG. 4B. (“flow”) without entering a submission action. In response to the modification, the user interface is dynamically updated to display search results 438 responsive to the updated search query 436.

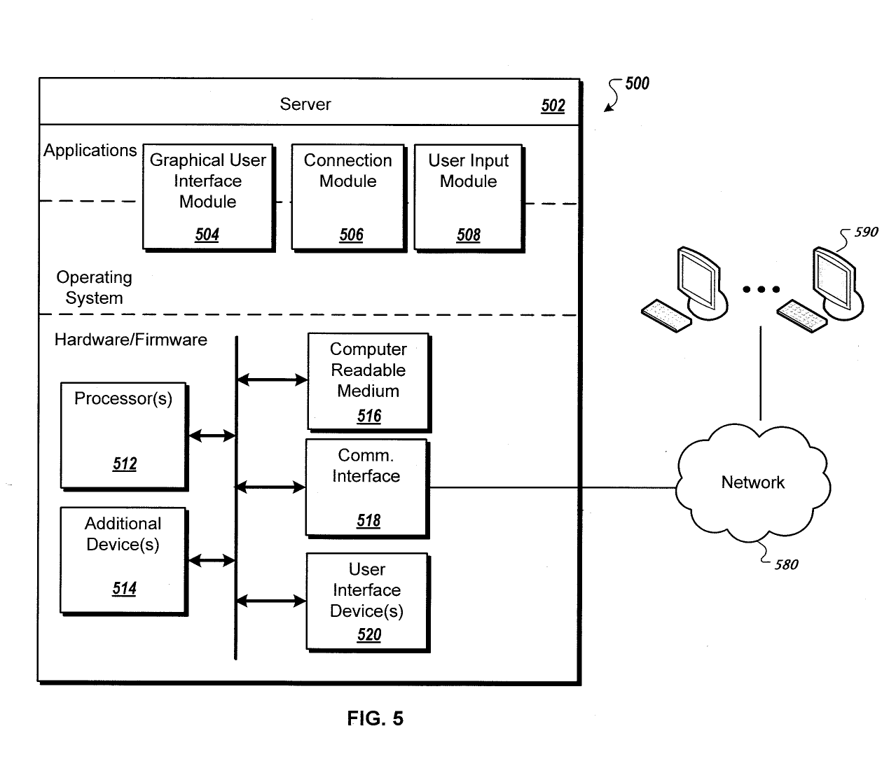

FIG. 5 is a schematic diagram of an example system 500. A system 502 is optionally connected to one or more servers 590 through a network 580. The system 502 consists of one or more data processing apparatuses. While only one data processing apparatus is shown in FIG. 5, multiple data processing apparatus can be used. The system 502 includes various software modules, e.g. executable software programs or libraries, including one or more of: a graphical user interface 504, a connection module 506, and a user input module 508. Although several software modules are illustrated, there may be fewer or more software modules.

The system 502 also includes hardware or firmware devices including one or more processors 512, one or more additional devices 514, a computer readable medium 516, a communication interface 518, and one or more user interface devices 520. Each processor 512 is capable of processing instructions for execution within the system 502. In some implementations, the processor 512 is a single or multi-threaded processor. Each processor 512 is capable of processing instructions stored on the computer readable medium 516 or on a storage device such as one of the additional devices 514. The system 502 uses its communication interface 518 to communicate with one or more computers 590, for example, over a network 580. Examples of user interface devices 520 include a display, a camera, a speaker, a microphone, a tactile feedback device, a keyboard, and a mouse. The system 502 can store instructions that implement operations associated with the modules described above, for example, on the computer readable medium 516 or one or more additional devices 514, for example, one or more of a floppy disk device, a hard disk device, an optical disk device, or a tape device.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, the method comprising:
obtaining one or more characters in a first string of characters entered by a user into an input field of a graphical user interface, wherein the first string of characters corresponds to a first uniform resource locator, and wherein the input field is an address bar of a web browser application;
presenting a first web page in a graphical user interface, the first web page being identified by the first uniform resource locator;
after presenting the first web page, obtaining one or more characters in a second string of characters entered by the user into the input field, wherein the second string of characters corresponds to a second uniform resource locator, and before a submission action is received from the user:
replacing the presentation of the first web page with a presentation of a second web page, the second web page being identified by the second uniform resource locator;
after replacing the presentation, receiving one or more backspace characters entered into the input field that edit the input field to generate a third string of characters in the input field that is different from the first uniform resource locator and not a prefix of the first uniform resource locator; and
in response to receiving the one or more backspace characters that edit the input field to generate the third string of characters in the input field that is different from the first uniform resource locator and not a prefix of the first uniform resource locator, replacing the presentation of the second web page with the presentation of the first web page.

2. The method of claim h wherein the one or more characters in the third string of characters is a substring of the second uniform resource locator, and wherein the third string of characters does not resolve to the first web page identified by the first uniform resource locator.

3. (canceled)

4. The method of claim 1 wherein the submission action is entry of a non-alphanumeric character or selection of a visual element of the graphical user interface.

5. The method of claim 4 wherein the visual element is a button.

6. (canceled)

7. (canceled)

8. (canceled)

9. A system comprising:
one or more processors configured to interact with a non-transitory computer storage medium in order to perform operations comprising:
obtaining one or more characters in a first string of characters entered by a user into an input field of a graphical user interface, wherein the first string of characters corresponds to a first uniform resource locator, and wherein the input field is an address bar of a web browser application;
presenting a first web page in a graphical user interface, the first web page being identified by the first uniform resource locator;
after presenting the first web page, obtaining one or more characters in a second string of characters entered by the user into the input field, wherein the second string of characters corresponds to a second uniform resource locator, and before a submission action is received from the user:
replacing the presentation of the first web page with a presentation of a second web page, the second web page being identified by the second uniform resource locator;
after replacing the presentation, receiving one or more backspace characters entered into the input field that edit the input field to generate a third string of characters in the input field that is different from the first uniform resource locator and not a prefix of the first uniform resource locator; and
in response to receiving the one or more backspace characters that edit the input field to generate the third string of characters in the input field that is different from the first uniform resource locator and not a prefix of the first uniform resource locator, replacing the presentation of the second web page with the presentation of the first web page.

10. The system of claim 9, wherein the one or more characters in the third string of characters is a substring of the second uniform resource locator, and wherein the third string of characters does not resolve to the first web page identified by the first uniform resource locator.

11. (canceled)

12. The system of claim 9 wherein the submission action is entry of a non-alphanumeric character or selection of a visual element of the graphical user interface.

13. The system of claim 12 wherein the visual element is a button.

14. (canceled)

15. (canceled)

16. (canceled)

17. A non-transitory computer storage medium encoded with a computer program, the program comprising instructions that when executed by one or more data processing apparatus cause the data processing apparatus to perform operations comprising:
obtaining one or more characters in a first string of characters entered by a user into an input field of a graphical user interface, wherein the first string of characters corresponds to a first uniform resource locator, and wherein the input field is an address bar of a web browser application;
presenting a first web page in a graphical user interface, the first web page being identified by the first uniform resource locator;
after presenting the first web page, obtaining one or more characters in a second string of characters entered by the user into the input field, wherein the second string of characters corresponds to a second uniform resource locator, and before a submission action is received from the user:
replacing the presentation of the first web page with a presentation of a second web page, the second web page being identified by the second uniform resource locator;
after replacing the presentation, receiving one or more backspace characters entered into the input field that edit the input field to generate a third string of characters in the input field that is different from the first uniform resource locator and not a prefix of the first uniform resource locator; and
in response to receiving the one or more backspace characters that edit the input field to generate the third string of characters in the input field that is different from the first uniform resource locator and not a prefix of the first uniform resource locator, replacing the presentation of the second web page with the presentation of the first web page.

18. The computer storage medium of claim 17, wherein the one or more characters in the third string of characters is a substring of the second uniform resource locator, and wherein the third string of characters does not resolve to the first web page identified by first uniform resource locator.

19. (canceled)

20. The computer storage medium of claim 17 wherein the submission action is entry of a non-alphanumeric character or selection of a visual element of the graphical user interface.

21. The computer storage medium of claim 20 wherein the visual element is a button.

22. (canceled)

23. (canceled)

24. (canceled)

25. The method of claim 1, wherein the third string of characters corresponds to a third uniform resource locator that specifies a different domain than the first uniform resource locator.

26. The system of claim 9, wherein the third string of characters corresponds to a third uniform resource locator that specifies a different domain than the first uniform resource locator.

27. The computer storage medium of claim 17, wherein the third string of characters corresponds to a third uniform resource locator that specifies a different domain than the first uniform resource locator.
